(19) United States
(12) Patent Application Publication
(10) Pub. No.: US 2023/0065823 A1
(43) Pub. Date: Mar. 2, 2023

(54) UPDATING RECORDS IN A REAL-TIME STORAGE SYSTEM

(71) Applicant: Twitter, Inc., San Francisco, CA (US)

(72) Inventor: Rakesh Iyer, Sunnyvale, CA (US)

(21) Appl. No.: 17/410,515

(22) Filed: Aug. 24, 2021

(51) Int. Cl. G06F 16/23

(52) U.S. Cl. CPC G06F 16/2358; G06F 16/2322; G06F 16/2365

(57) ABSTRACT

According to an aspect, a method includes storing messages exchanged on a messaging platform in a non-relational database, obtaining a database snapshot of the non-relational database, executing a database task on the database snapshot, and generating, in response to the database task, an update log, where the update log identifies a first record to be changed or deleted in the non-relational database. The method includes determining whether or not the first record identified in the update log has been updated in the non-relational database after a time instance associated with the database task and applying the change or deletion of the first record in the non-relational database in response to the first record being determined as not updated after the time instance associated with the database task.

### BACKGROUND

A real-time storage system may store thousands or millions of records. In some examples, a messaging system uses the real-time storage system to store messages exchanged among user devices. If a user leaves the messaging system, their user account and the messages of that user are typically deleted. Also, the messaging system's storage system may include a number of different datasets, and the user's data may be stored in multiple locations. For a relatively large messaging system, in some examples, hundreds or thousands of users may join or leave the platform in a single day. As such, the messaging system may be required to perform a database task (e.g., a large-scale task) on the storage system in order to search and delete the hundreds or thousands of users that leave the platform, which may be stored in multiple locations. Also, with the exchange of millions of messages among its users (e.g., in a single day), the database may be constantly updated. As such, in some examples, the use of indexes to search and retrieve records may be relatively slow and may increase the volume of data in an already high volume database, thereby leading to additional computational costs in maintaining the data.

### SUMMARY

This disclosure relates to techniques for updating records in a non-relational database in a manner that increases the speed of updating records and/or reduces the computational costs of implementing changes to the records of the non-relational database. Also, the techniques discussed herein may implement the changes to the records in the non-relational database in a manner that is consistent among the different datasets of the non-relational database. In some examples, the system includes a messaging system that stores messages exchanged on a messaging platform in the non-relational database. In some examples, the messaging platform may transmit thousands or millions of messages among its users (e.g., in a single day), therefore, the non-relational database (e.g., the real-time database) may be updated at a relatively fast rate. The speed at which the non-relational database would need to be updated may be too fast to search and retrieve its records using an index. Also, the use of indexes to search and retrieve records may increase the volume of data in an already high volume database, thereby leading to additional computational costs in maintaining the data. Therefore, the non-relational database may not include or be associated with database indexes.

The non-relational database may include a plurality of datasets. For example, the datasets may include a main dataset that stores the messages exchanged on the messaging platform. Also, the datasets may include derived datasets that are obtained by one or more data services associated with the messaging platform. The derived datasets may store message and/or user information. In other words, the derived datasets may include some of the messages exchanged on the messaging platform (or portions thereof) and/or user information relating to the messages. For example, a data service of the messaging platform may relate to an advertisement service in which its derived dataset includes message and/or user information about a certain product or service. The messaging platform may include tens, hundreds, or thousands of derived datasets.

The messaging system may execute database tasks (e.g., large-scale database tasks) that change or delete the records of the non-relational database. A database task may be any type of modification operation that applies to all or a subset of the records stored in the non-relational database. For example, a database task may relate to modifying a message identifier associated with the messages (e.g., changing from a 32-bit identifier to a 64-bit identifier). A database task may relate to replacing a certain value with a different value (e.g., a global replace). A database task may relate to deleting message and user information for accounts that leave the messaging platform.

For example, a user may unsubscribe to the messaging platform (e.g., delete their user account), which would then cause the deletion of the user's information (e.g., messages, profile data) stored in the non-relational database. In some examples, since the non-relational database does not include an index by user, the messaging platform may have to search the thousands or millions of records in the non-relational database to determine which records correspond to the user. Also, in some examples, a relatively large number of users (e.g., thousands or millions) may unsubscribe to the messaging platform (thereby causing their deletion of data in the non-relational database) around the same time (e.g., in the same day), thereby repeatedly re-searching thousands or millions of records in the non-relational database.

As further discussed below, this disclosure provides a continuous multi-pass batch processing system that can efficiently solve a large-scale problem on a real-time database. For example, the messaging platform may include a database manager configured to obtain, over time, a sequence of database snapshots (e.g., a first database snapshot, followed by a second database snapshot, and so forth) of the non-relational database. For example, the database manager may periodically generate a database snapshot (e.g., once a day, once a week, once a month, etc.) from the non-relational database. A database snapshot may be a copy of the records of the non-relational database at a particular time or during a period of time. The database manager may extract the information for a database snapshot using batch processing and store the database snapshot in an offline storage system such as a Hadoop filesystem.

The messaging platform may include a task manager configured to execute database tasks using the database snapshots stored in the offline storage system. In some examples, the task manager is configured to execute in batch mode with offline data (e.g., Hadoop map reduce jobs). For example, the task manager may execute a database task on the first database snapshot. The database task may be any type of database task (e.g., large-scale database task), including modification and/or deletion events that relate to all the records or a portion of the records stored in the non-relational database. In response to the database task, the task manager generates an update log, where the update log identifies records to be modified or deleted in the non-relational database according to the database task. In some examples, the update log includes a plurality of rows, where each row corresponds to a separate record to be modified in the non-relational database. In some examples, each row includes original data from the record (e.g., from the database snapshot) and the modifications for that row (e.g., the modifications as indicated by the database task). In some examples, a row deletion is a special case of row modification to a null row.

The messaging platform includes a change applier configured to receive the update log and determine, for each record identified on the update log, whether or not to apply the update based on whether or not the record has been updated after a time instance associated with the database task. If the record has been updated after the time instance associated with the database task, the modification or deletion is not applied to the record in the non-relational database. If the record has not been updated after the time instance associated with the database task, the modification or deletion is applied to the record in the non-relational database.

In some examples, the change applier may compare timestamps to determine whether the record stored in the non-relational database has been updated after a time instance associated with the database task. For example, the change applier may compare a first timestamp associated with the record in the non-relational database and a second timestamp associated with the record in the first database snapshot, and if the time indicated by the first timestamp is after the time indicated by the second timestamp, the change applier may not apply the change or deletion of the record in the non-relational database. If the time indicated by the first timestamp is before the time indicated by the second timestamp, the change applier may apply the change or deletion of the record in the non-relational database.

In some examples, instead of (or addition to) using timestamps, the change applier may compare the contents of the record from the update log (e.g., the content of the record in the first database snapshot) with the contents of the record in the non-relational database. If they are the same, the change applier may apply the change or deletion to the record in the non-relational database. If they are different, the change applier may not apply the change or deletion to the record in the non-relational database. In some examples, the change applier may use compare-and-swap (CAS) operations to compare the contents.

For changes or deletions that were not applied to the non-relational database, the system may use subsequent database snapshots to determine whether to apply those changes or deletions. For example, if the contents of a record has changed from a time instance associated with the database task, the change or deletion may be deferred to a subsequent time. For instance, after the second database snapshot is obtained, the database task is re-executed using the second database snapshot, which re-generates an update log identifying a record to be changed or deleted. Then, the change applier is configured to determine whether or not to apply the update based on whether or not the record has been updated after a time instance associated with the re-executed database task (e.g., using timestamps or comparing content between the record in the non-relational database and the second database snapshot). The database task may be periodically re-executed using subsequent database snapshots (e.g., third database snapshot, fourth database snapshot, etc.) over a period of time to ensure that the modifications or deletions are implemented to all the records that are subject to the database task.

The above-techniques may also cause the data to be updated in a consistent manner among the different datasets of the non-relational database. For example, the data services may update their records in the derived datasets, and some of these records may be subject to the database task. If the updates were implemented after a time associated with the database task, execution of the database task on those later-updated records may cause inconsistencies in the state of the data stored by the records. A database task may be generated to delete or modify a plurality of records in the non-relational database at 2 PM on July 1^{st}. The plurality of records that are subject to the database task may be stored in the main dataset and a derived dataset. A data service may update a record stored in the derived dataset at 3 PM on July 1^{st}. After 2 PM on July 1^{st}, the task manager may use the current database snapshot to search the non-relational database and identify the record stored in the derived dataset. The update to the record at 3 PM by the data service may cause the record to not be applicable to the database task. However, the change applier is configured to determine whether or not to apply the update (e.g., based on whether the record has been updated after a time instance associated with the database task). If the record has been updated after a time instance associated with the database task, the update is deferred, and the database task is re-executed using a subsequent database snapshot. In this manner, records may be updated in the non-relational database in a consistent manner.

According to an aspect, a method includes storing messages exchanged on a messaging platform in a non-relational database, obtaining a database snapshot of the non-relational database, executing a database task on the database snapshot, and generating, in response to the database task, an update log, where the update log identifies a first record to be changed or deleted in the non-relational database. The method includes determining whether or not the first record identified in the update log has been updated in the non-relational database after a time instance associated with the database task and applying the change or deletion of the first record in the non-relational database in response to the first record being determined as not updated after the time instance associated with the database task.

According to some aspects, the method may include one or more of the following features (or any combination thereof). The method may include not applying the change or deletion of the first record in the non-relational database in response to the first record being determined as updated after the time instance associated with the database task. The method may include comparing a first timestamp associated with the first record in the non-relational database and a second timestamp associated with the first record in the database snapshot, where the change or deletion of the first record in the non-relational database is applied in response to a time of the first timestamp being before a time of the second timestamp. The method may include comparing a content of the first record in the database snapshot with a content of the first record in the non-relational database, where the change or deletion of the first record in the non-relational database is applied in response to the content of the first record in the non-relational database being determined as the same as the content of the first record in the database snapshot. The method may include obtaining a sequence of database snapshots over time, the sequence of database snapshots including a first database snapshot obtained during a first period of time, and a second database snapshot obtained during a second period of time. In some examples, the database snapshot is a first database snapshot, and the method includes obtaining a second database snapshot of the non-relational database, where the second database snapshot is obtained after the first database snapshot. The method may include re-generating, in response to a subsequent database task, the update log, the re-generated update log identifying the first record, determining whether or not the first record identified in the re-generated update log has been updated in the non-relational database after a time instance associated with the subsequent database task, and applying the change or deletion of the first record in the non-relational database in response to the first record being determined as not changed after the time instance associated with the subsequent database task. The method may include storing the database snapshot in an offline storage system, the offline storage system being separate from the non-relational database. The database task may be a deletion event configured to delete records in the non-relational database associated with a plurality of user accounts of the messaging platform. The first record may include a message exchanged on the messaging platform from a user account of the plurality of user accounts, where the message has a message identifier, and the database task is configured to cause deletion of any records associated with the message identifier from the non-relational database.

According to an aspect, a messaging system includes a non-relational database configured to store messages exchanged on a messaging platform in a non-relational database, a database manager configured to obtain, over time, a sequence of database snapshots of the non-relational database, the sequence of database snapshots including a first database snapshot, a task manager configured to execute a database task on the first database snapshot to generate an update log, the update log identifying a plurality of records to be changed or deleted in the non-relational database, and a change applier configured to determine, for each of the plurality of records identified in the update log, whether or not a record has been updated in the non-relational database after a time instance associated with the database task. The change applier is configured to apply the change or deletion of the record in the non-relational database in response to the record being determined as not updated after the time instance associated with the database task.

According to some aspects, the messaging system may include one or more of the following features (or any combination thereof). The non-relational database may be an unstructured database, where the unstructured database does not include an index. The change applier is configured to not apply the change or deletion of the record in the non-relational database in response to the record being determined as updated after the time instance associated with the database task. The change applier is configured to compare a first timestamp associated with the record in the first database snapshot with a second timestamp associated with the record stored in the non-relational database. The change applier is configured to not change or delete the record in the non-relational database in response to a time of the second timestamp being after a time of the first timestamp. The change applier is configured to compare a content of the first record in the first database snapshot with a content of the first record in the non-relational database. The change applier is configured to not change or delete the record in the non-relational database in response to the content of the first record in the non-relational database being different from the content of the first record in the first database snapshot. The sequence of database snapshots may include a second database snapshot. The task manager is configured to re-generate, in response to a subsequent database task, the update log using the second database snapshot.

According to an aspect, a non-transitory computer-readable medium storing executable instructions that when executed by at least one processor cause the at least one processor to store messages exchanged on a messaging platform in a non-relational database, obtain, over time, a sequence of database snapshots of the non-relational database, where the sequence of database snapshots includes a first database snapshot and a second database snapshot, execute a database task on the first database snapshot to generate an update log, where the update log identifies a plurality of records to be changed or deleted in the non-relational database, determine, for each of the plurality of records identified in the update log, whether or not a record has been updated in the non-relational database after a time instance associated with the database task, not apply the change or deletion of the record in the non-relational database in response to the record being determined as updated after the time instance associated with the database task, and attempt to apply the change or deletion of the record in the non-relational database using the second database snapshot.

According to some aspects, the non-transitory computer-readable medium may include one or more of the following features (or any combination thereof). The executable instructions include instructions that when executed by the at least one processor cause the at least one processor to compare a first timestamp associated with the record in the first database snapshot with a second timestamp associated with the record stored in the non-relational database and not change or delete the record in the non-relational database in response to a time of the second timestamp being after a time of the first timestamp. The executable instructions include instructions that when executed by the at least one processor cause the at least one processor to compare a content of the first record in the first database snapshot with a content of the first record in the non-relational database using one or more compare-and-swap (CAS) operations and not change or delete the record in the non-relational database in response to the content of the first record in the non-relational database being different from the content of the first record in the first database snapshot. The database task may be a deletion event configured to delete records in the non-relational database associated with a plurality of user accounts that are unsubscribed from the messaging platform. The non-relational database may include a main dataset and at least one derived dataset, where the plurality of records include messages exchanged on the messaging platform from the plurality of user accounts. The database task is configured to cause deletion of any records associated with the plurality of user accounts from the main dataset and the at least one derived dataset.

### BRIEF DESCRIPTION OF DRAWINGS

FIG. 1 illustrates a system for updating records in a non-relational database according to an aspect.

FIG. 2 illustrates a non-relational database according to an aspect.

FIG. 3 illustrates a database manager configured to obtain a sequence of database snapshots of the non-relational database according to an aspect.

FIG. 4 illustrates example operations of a change applier configured to determine whether or not to apply a change to records of the non-relational database according to an aspect.

FIG. 5 illustrates a change applier configured to receive an update log and determine whether or not to implement a change to records identified by the update log according to an aspect.

FIG. 6 illustrates a flowchart depicting example operations of a system for updating records according to an aspect.

### DETAILED DISCLOSURE

This disclosure relates to techniques for updating records in a non-relational database. The system may include a messaging system that stores messages exchanged on a messaging platform in the non-relational database. The messaging system may execute database tasks (e.g., large-scale database tasks) that change or delete the records of the non-relational database. A database task may be any type of modification operation that applies to all or a subset of the records stored in the non-relational database.

The messaging platform may include a database manager configured to obtain, over time, a sequence of database snapshots of the non-relational database. For example, the database manager may periodically generate a database snapshot (e.g., once a day, once a week, once a month, etc.) from the non-relational database. A database snapshot may be a copy of the records of the non-relational database at a particular time or during a period of time. The database snapshots may be stored in an offline storage system.

The messaging platform may include a task manager configured to execute database tasks using the database snapshots stored in the offline storage system. For example, the task manager may execute a database task on the first database snapshot. The database task may be any type of database task, including modification and/or deletion events that relate to all the records or a portion of the records stored in the non-relational database. In response to the database task, the task manager generates an update log, where the update log identifies records to be modified or deleted in the non-relational database according to the database task.

The messaging platform includes a change applier configured to receive the update log and determine, for each record identified on the update log, whether or not to apply the update based on whether or not the record has been updated after a time instance associated with the database task. If the record has not been updated after the time instance associated with the database task, the modification or deletion is applied to the record in the non-relational database. If the record has been updated after the time instance associated with the database task, the modification or deletion is not applied to the record in the non-relational database. In some examples, the update is deferred, and the database task is re-executed using a subsequent database snapshot. For example, the database task may be periodically re-executed using subsequent database snapshots over a period of time to ensure that the modifications or deletions are implemented to the records that are subject to the database task.

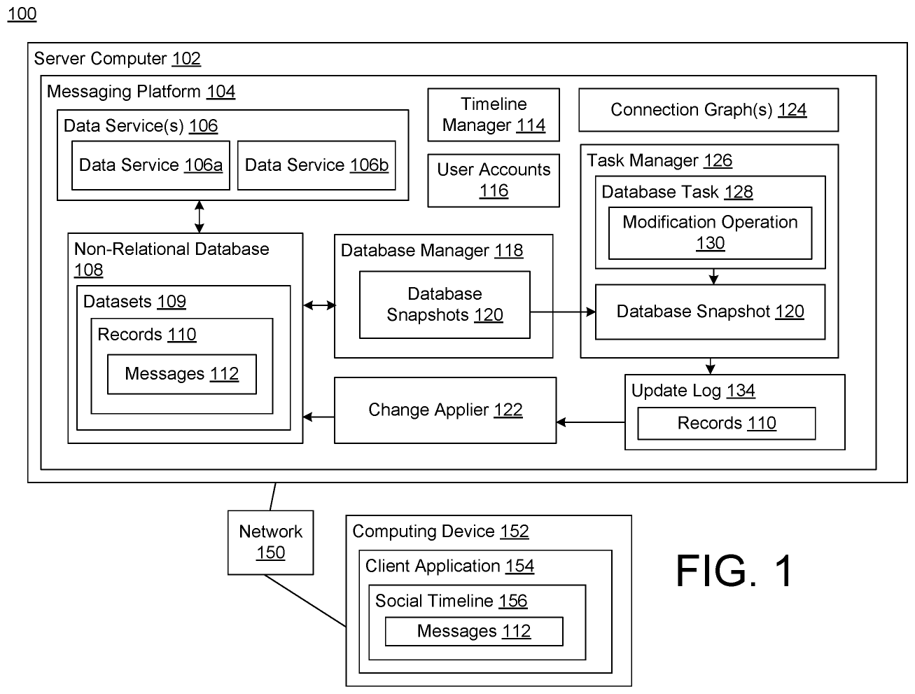

FIGS. 1 through 5 illustrate a system 100 for updating records 110 in a non-relational database 108 according to an aspect. The non-relational database 108 may store messages 112 exchanged on a messaging platform 104. For example, the system 100 includes a messaging platform 104 executable by a server computer 102, and a client application 154 executable by a computing device 152 according to an aspect. The client application 154 may communicate with the messaging platform 104 to send (and receive) messages, over a network 150, to (and from) other users of the messaging platform 104.

The client application 154 may be a messaging application (e.g., a social media messaging application) in which users post and interact with messages 112. In some examples, the client application 154 is a native application executing on an operating system of the computing device 152 or may be a web-based application executing on the server computer 102 (or other server) in conjunction with a browser-based application of the computing device 152. The client application 154 may access the messaging platform 104 via the network 150 using any type of network connections and/or application programming interfaces (APIs) in a manner that permits the client application 154 and the messaging platform 104 to communicate with each other.

The computing device 152 may be a mobile computing device (e.g., a smart phone, a PDA, a tablet, or a laptop computer, etc.) or a non-mobile computing device (e.g., a desktop computing device). The computing device 152 also includes various network interface circuitry, such as for example, a mobile network interface through which the computing device 152 can communicate with a cellular network, a Wi-Fi network interface with which the computing device 152 can communicate with a Wi-Fi base station, a Bluetooth network interface with which the computing device 152 can communicate with other Bluetooth devices, and/or an Ethernet connection or other wired connection that enables the computing device 152 to access the network 150.

The server computer 102 may be a single computing device or may be a representation of two or more distributed computing devices communicatively connected to share workload and resources. The server computer 102 may include at least one processor and a non-transitory computer-readable medium that stores executable instructions that when executed by the at least one processor cause the at least one processor to perform the operations discussed herein.

The messaging platform 104 is a computing platform for facilitating communication (e.g., real-time communication) between user devices (one of which is shown as computing device 152). The messaging platform 104 may store millions of user accounts 116 of individuals, businesses, and/or entities (e.g., pseudonym accounts, novelty accounts, etc.). One or more users of each user account 116 may use the messaging platform 104 to send messages 112 to other user accounts 116 inside and/or outside of the messaging platform 104. In some examples, the messaging platform 104 may enable users to communicate in “real-time”, e.g., to converse with other users with minimal delay and to conduct a conversation with one or more other users during simultaneous sessions. In other words, the messaging platform 104 may allow a user to broadcast messages 112 and may display the messages 112 to one or more other users within a reasonable time frame (e.g., less than two seconds) to facilitate a live conversation between users. In some examples, recipients of a message 112 may have a predefined graph relationship in a connection graph 124 with a user account 116 of the user broadcasting the message 112.

The connection graph 124 includes a data structure that indicates which user accounts 116 in the messaging platform 104 are associated with (e.g., following, friends with, subscribed to, etc.) a particular user account 116 and are, therefore, subscribed to receive messages 112 from the particular user account 116. For example, the connection graph 124 may link a first account with a second account, which indicates that the first account is in a relationship with the second account. The user of the second account may view messages 112 posted on the messaging platform 104 by the user of the first account (and/or vice versa). The relationships defined by the connection graph 124 may include unidirectional (e.g., follower/followee) and/or bidirectional (e.g., friendship). The messages 112 can be any of a variety of lengths which may be limited by a specific messaging system or protocol.

In some examples, users interested in viewing messages 112 authored by a particular user can choose to follow, be friends with, or subscribe to the particular user. Although the term follow is sometimes used throughout the disclosure, generally the term follows refers to the establishment of a relationship (e.g., unidirectional or bidirectional) between user accounts. A first user can follow a second user by identifying the second user as a user the first user would like to follow. After the first user has indicated that they would like to follow the second user, the connection graph 124 is updated to reflect the relationship (e.g., a link or edge is generated between a first node representing a first user account and a second node representing a second user account), and the first user will be provided with messages 112 authored by the second user. Users can choose to follow multiple users. Users can also respond to messages and thereby have conversations with one another. In addition, users may engage with messages 112 such as sharing a message with their followers or favoritizing (or “liking”) a message 112 in which the engagement is shared with their followers.

The messaging platform 104 includes a timeline manager 114 that injects messages into a social timeline 156 of a user of the client application 154. The timeline manager 114 may send digital information, over the network 150, to enable the client application 154 to render and display a social timeline 156 of social content on the user interface of the client application 154. The social timeline 156 includes a stream of messages 112. In some examples, the stream of messages 112 are arranged in reverse chronological order. In some examples, the stream of messages 112 are arranged in chronological order. In some examples, the social timeline 156 is a timeline of social content specific to a particular user. In some examples, the social timeline 156 includes a stream of messages curated (e.g., generated and assembled) by the messaging platform 104. In some examples, the social timeline 156 includes a list of messages that resulted from a search on the messaging platform 104. In some examples, the social timeline 156 includes a stream of messages posted by users from user accounts 116 that are in relationships with the user account 116 of the user of the client application 154 (e.g., a stream of messages from user accounts 116 that the user has chosen to follow on the messaging platform 104). In some examples, the stream of messages 112 includes promoted messages, or messages that have been re-shared.

Messages 112 exchanged on the messaging platform 104 are stored in the non-relational database 108. The non-relational database 108 may include one or more datasets 109 storing records 110. In some examples, each record 110 corresponds to a separately stored message 112. For example, a record 110 may identify a message identifier for the message 112 posted to the messaging platform 104, an author identifier (e.g., @tristan) that identifies the author of the message 112, message content (e.g., text, image, video, and/or URL of web content), one or more participant account identifiers that have been identified in the body of the message 112, and/or reply information that identifies the parent message for which the message replies to (if the message is a reply to a message).

The non-relational database 108 may be an unstructured database. An unstructured database stores information (e.g., non-relational information) that is not arranged according to a pre-set data model or scheme. In some examples, the non-relational database 108 is a real-time storage system (e.g., that creates a record 110 as the user posts the message 112 to the messaging platform 104 in real-time or near real-time). In some examples, the non-relational database 108 does not use structured query language (SQL) for database queries. In some examples, the non-relational database 108 includes hundreds of columns. In some examples, the non-relational database 108 includes thousands of columns.

In some examples, the non-relational database 108 does not include (or is not associated) with a database index (e.g., index or index structure) for data retrieval and/or modification operations. For example, indexing is a way of sorting a number of records on multiple fields, where creating an index on a field in a table creates another data structure which holds the field value and a pointer to the record it relates to. This index is then sorted, allowing searches (e.g., binary searches) to be performed on the index. However, with the exchange of thousands or millions of messages 112 among its users (e.g., in a single day), the non-relational database 108 is constantly being updated. The speed at which the non-relational database 108 would need to be updated may be too fast to search and retrieve its records 110 using an index. Also, the use of indexes to search and retrieve records may increase the volume of data in an already high volume database, thereby leading to additional computational costs in maintaining the data. Therefore, the non-relational database 108 may not include or be associated with database indexes.

The non-relational database 108 may include a key-value database (e.g., an unstructured key-value store). A key-value database may allow a program or users of a program to retrieve data by at least one key (e.g., a primary key), which may be names or identifiers that point to some stored value. In some examples, the non-relational database 108 uses messages identifiers of the messages 112 as the primary key to retrieve data and perform a database operation with respect to the data (e.g., retrieving a value stored and associated with a given key, deleting the value stored and associated with a given key, and/or setting, updating, and/or replacing the value associated with a given key).

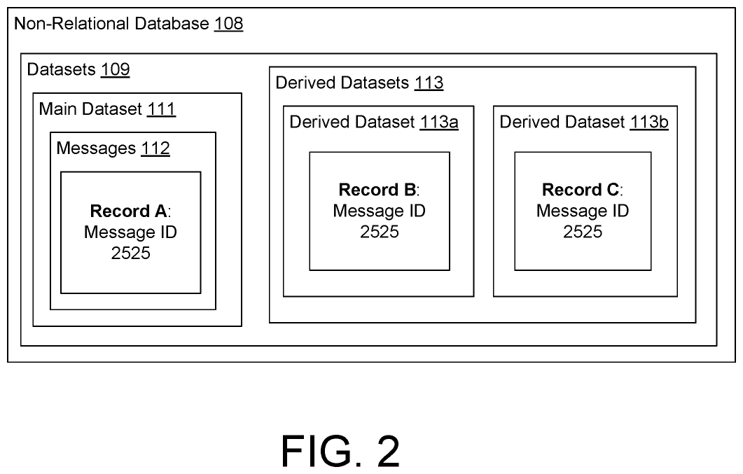

As shown in FIG. 2, the non-relational database 108 may include a plurality of datasets 109. The dataset 109 is a collection of data. In the case of tabular data, a data set corresponds to one or more database tables, where every column of a table represents a particular variable and each row corresponds to a given record in the data set. The datasets 109 may include a main dataset 111 and one or more derived datasets 113. The main dataset 111 may store the messages 112 that are exchanged on the messaging platform 104. For example, the main dataset 111 may represent the main storage for messages exchanged on the messaging platform 104. The non-relational database 108 may include tens, hundreds, or thousands of derived datasets 113.

The messaging platform 104 may include one or more data services 106 that use the main dataset 111 to create one or more derived datasets 113. A data service 106 may be any type of service that uses messages 112 in the main dataset 111 to create a subset of messages 112 in a derived dataset 113 for computation and/or analysis. In some examples, a data service 106 may be a component on the messaging platform 104 that computes or otherwise derives data obtained by the messaging platform 104 and/or the client application 154. In some examples, the data service(s) 106 may communicate with other components of the messaging platform 104 over a server communication interface (e.g., application programming interfaces (APIs), thrift call or a remote procedure call (RPC), a representational state transfer (REST) request, etc.). In one example, a data service 106 may relate to generating advertising revenue, where the data service 106 can use the messages 112 in the main dataset 111 to create a derived dataset 113, which is analyzed for generating advertising revenue. A data service 106a may create or use a derived dataset 113a. Another data service 106 (e.g., data service 106b) may create or use a derived dataset 113b. In some examples, a derived dataset 113 may include notifications about messages 112 or user profile changes to client devices such as phones, tablets, laptops, etc. In some examples, a derived dataset 113 may include information relating to conversation controls such as limiting conversations to a particular set of users. In some examples, a derived dataset 113 includes information about blocking users from access to messages 112 or other user accounts 116.

As shown in FIG. 2, the main dataset 111 may include record A having a message identifier (e.g., “2525”) for a message 112 posted to the messaging platform 104 by user A. Record A may identify a message identifier (e.g., “2525”), an author identifier (e.g., @UserA) that identifies the author of the message 112, message content (e.g., text, image, video, and/or URL of web content), one or more participant account identifiers that have been identified in the body of the message 112, and/or reply information that identifies the parent message for which the message replies to (if the message is a reply to a message). The derived dataset 113a may store Record B. Record B may identify the same message (e.g., “2525”) and may include the message content (or a portion thereof) or some user data associated with user A. The derived dataset 113b may store Record C. Record C may identify the same message (e.g., “2525”) and may include the message content (or a portion thereof) or some user data associated with user A.

A user may unsubscribe to the messaging platform 104 (e.g., delete their user account 116), which would then cause the deletion of the user's information (e.g., messages 112) in the messaging platform 104 across the datasets 109. In some examples, since the non-relational database 108 does not include an index by user, the messaging platform 104 may have to search the thousands or millions of records 110 in the non-relational database 108 to determine which records 110 correspond to the user. Also, in some examples, a relatively large number of users (e.g., thousands or millions) may unsubscribe to the messaging platform 104 (thereby causing their deletion of data in the non-relational database 108) around the same time (e.g., in the same day), thereby repeatedly re-searching thousands or millions of records 110 in the non-relational database 108.

However, according to the embodiments discussed herein, the messaging platform 104 includes a database manager 118 configured to generate, over time, a sequence of database snapshots 120 of the non-relational database 108. The database manager 118 may create the database snapshots 120 using batch processing. In some examples, the database manager 118 may extract the information for a database snapshot 120 from the non-relational database 108 through a service level agreement (SLA) extraction (e.g., a relaxed SLA extraction). In some examples, the extraction of the information for a database snapshot 120 is a low-cost operation (e.g., requiring less processing power, less memory) due to the relaxed SLA extraction and the batching of the database information. A relaxed SLA extraction is an extraction operation in which one or more constraints are removed. In some examples, the database manager 118 may store the database snapshots 120 in an offline storage system. In some examples, the offline storage system includes a distributed file system. In some examples, the offline storage system includes a Hadoop filesystem.

The database manager 118 may periodically generate a database snapshot 120 (e.g., once a week, once a day, once a month, etc.). In some examples, the database manager 118 generates a database snapshot 120 in response to expiration of a certain period of time. A database snapshot 120 may be a copy of the records 110 during a time period 136. The database snapshot 120 may include any records 110 in the main dataset 111 and any records 110 in the derived datasets 113a at a particular point or particular period of time. In some examples, the non-relational database 108 is very large, where the database snapshot 120 is not obtained at a particular instance but is gathered over a period of time (e.g., 6-hours, 12-hours, 24-hours, etc.).

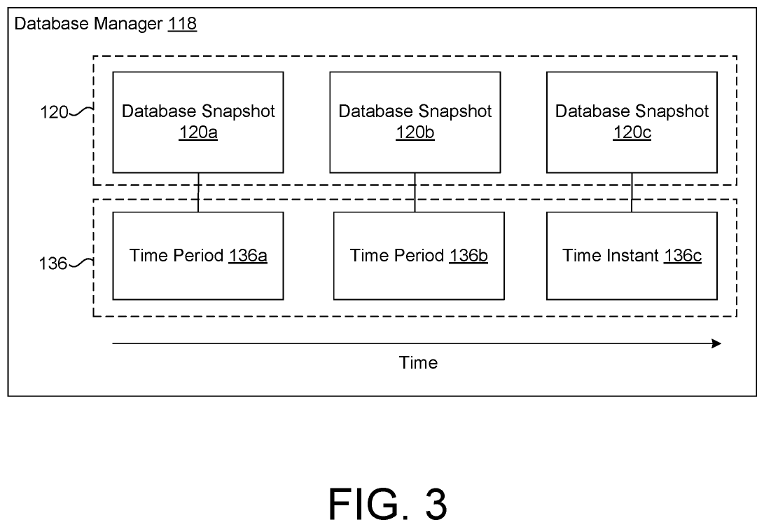

Referring to FIG. 3, the database manager 118 may generate a database snapshot 120a during a time period 136a, a database snapshot 120b during a time period 136b, and a database snapshot 120c during a time period 136c, and so forth. The database snapshot 120b may be generated after the database snapshot 120a is generated. The database snapshot 120c may be generated after the database snapshot 120b is generated. The database snapshot 120a may include the records 110 existing in the non-relational database 108 during the time period 136a. The time period 136a may be any interval of time (e.g., minutes, hours, days, a week, etc.). In some examples, the time period 136a is the length of time to obtain the database snapshot 120a. For example, the database manager 118 may begin to generate the database snapshot 120a on July 1 ^{st} at 8am and the database manager 118 may continue to collect the data for the database snapshot 120a to July 3^{rd} at noon or however long it takes to generate a copy of the records 110 in the non-relational database 108.

The database snapshot 120b may include the records 110 existing in the non-relational database 108 during the time period 136b. The time period 136b may be any interval of time (e.g., minutes, hours, days, a week, etc.). In some examples, the time period 136b is the length of time to obtain the database snapshot 120b, which may be the same or different from the time period 136a. For example, the database manager 118 may begin to generate the database snapshot 120b on July 9^{th} at 8am and the database manager 118 may continue to collect the data for the database snapshot 120b to July 11^{th} at noon or however long it takes to generate a copy of the records 110 in the non-relational database 108.

The database snapshot 120c may include the records 110 existing in the non-relational database 108 during the time period 136c. The time period 136c may be any interval of time (e.g., minutes, hours, days, a week, etc.). In some examples, the time period 136c is the length of time to obtain the database snapshot 120c, which may be the same or different from the time period 136a and/or the time period 136b. For example, the database manager 118 may begin to generate the database snapshot 120c on July 14^{th} at 8am and the database manager 118 may continue to collect the data for the database snapshot 120b to July 16^{th} at noon or however long it takes to generate a copy of the records 110 in the non-relational database 108.

The messaging platform 104 may include a task manager 126 configured to execute a database task 128 on the database snapshot 120a. The task manager 126 may execute the database tasks 128 on the database snapshots 120, which are stored in an offline store system. Execution of the database task 128 on the database snapshot 120a may include searching the database snapshot 120a to identify records 110 in the database snapshot 120a that are subject to the database task 128. In response to the database task 128, the task manager 126 generates an update log 134. The update log identifies records 110 to be changed or deleted in the non-relational database 108 according to the database task 128. In some examples, the update log 134 includes a plurality of rows, where each row corresponds to a separate record 110 to be modified in the non-relational database 108. In some examples, each row includes original data from the record 110 of the database snapshot 120a and the modifications for that row (e.g., the modifications as indicated by the database task 128). In some examples, a row deletion is a special case of row modification to a null row.

The database task 128 may include a modification operation 130 configured to identify records 110 in the database snapshot 120a that meet one or more conditions of the modification operation 130. In some examples, the modification operation 130 modifies data in one or more records 110. In some examples, the modification operation 130 deletes one or more records 110 (or a portion thereof). In some examples, the modification operation 130 adds information to one or more records 110. For example, a first user may unsubscribe to the messaging platform 104, which may initiate a modification operation 130 (e.g., a deletion event). The task manager 126 may obtain the database snapshot 120a and search the records 110 in the database snapshot 120a to generate an update log 134. The update log 134 may identify which records 110 (e.g., including the location of records 110) in the database snapshot 120a are associated with the first user. The update log 134 may include a plurality of rows, where each row includes a record 110 associated with the first user. In some examples, each row includes the original data contained in the record 110 within the database snapshot 120 and the modified data as modified by the modification operation 130.

In some examples, the database task 128 is a large-scale database task. In some examples, thousands or millions of users leave (and join) the messaging platform 104 over a period of time (e.g., daily, weekly, monthly, etc.). In some examples, the modification operation 130 may identify all the user accounts 116 to be deleted, and the task manager 126 is configured to search the database snapshot 120a to identify the messages 112 associated with the user accounts 116 to be deleted. The update log 134 identifies the records 110 associated with the message identifiers of messages 112 associated with the user accounts 116 to be deleted. Although the above example uses a deletion event, the database task 128 may be any type of a large-scale modification event.

The messaging platform includes a change applier 122 configured to receive the update log 134 and determine, for each record 110 identified on the update log 134, whether or not to apply the update based on whether or not the record 110 has been updated after a time instance associated with the database task 128. If the record 110 has been updated after the time instance associated with the database task 128, the modification or deletion is not applied to the record 110 in the non-relational database 108. If the record 110 has not been updated after the time instance associated with the database task 128, the modification or deletion is applied to the record 110 in the non-relational database 108.

In some examples, the change applier 122 may compare timestamps to determine whether the record 110 stored in the non-relational database 108 has been updated after a time instance associated with the database task 128. For example, the change applier 122 may compare a first timestamp associated with the record 110 in the non-relational database 108 and a second timestamp associated with the record 110 in the database snapshot 120a, and if the time indicated by the first timestamp is after the time indicated by the second timestamp, the change applier 122 may not apply the change or deletion of the record 110 in the non-relational database 108. If the time indicated by the first timestamp is before the time indicated by the second timestamp, the change applier 122 may apply the change or deletion of the record 110 in the non-relational database 108.

In some examples, instead of (or addition to) using timestamps, the change applier 122 may compare the contents of the record 110 from the update log 134 (e.g., the content of the record 110 in the database snapshot 120a ) with the contents of the record 110 in the non-relational database 108. If they are the same, the change applier 122 may apply the change or deletion to the record 110 in the non-relational database 108. If they are different, the change applier 122 may not apply the change or deletion to the record 110 in the non-relational database 108. In some examples, the change applier 122 may use compare-and-swap (CAS) operations to compare the contents.

For changes or deletions that were not applied to the non-relational database 108, the system 100 may use subsequent database snapshots 120 to determine whether to apply those changes or deletions. For example, if the contents of a record 110 has changed from a time instance associated with the database task 128, the change or deletion may be deferred to a subsequent time. For instance, after the database snapshot 120b is obtained, the database task 128 is re-executed using the database snapshot 120b, which re-generates an update log 134 identifying a record 110 to be changed or deleted. Then, the change applier 122 is configured to determine whether or not to apply the update based on whether or not the record 110 has been updated after a time instance associated with the re-executed database task 128 (e.g., using timestamps or comparing content between the record 110 in the non-relational database 108 and the database snapshot 120b). The database task 128 may be periodically re-executed using subsequent database snapshots 120 (e.g., database snapshot 120c, etc.) over a period of time to ensure that the modifications or deletions are implemented to all the records 110 that are subject to the database task 128. In some examples, if the modification operation 130 relates to a deletion event in which messages 112 are deleted for user accounts 116 that have been deleted on the messaging platform 104, the deletion event may be reattempted on subsequent database snapshots 120 for a period of time (e.g., 30-days).

The above-techniques may also cause the data to be updated in a consistent manner among the different datasets 109 of the non-relational database 108. For example, the data services 106 may update their records 110 in the derived datasets 113, and some of these records 110 may be subject to the database task 128. If the updates were implemented after a time associated with the database task 128, execution of the database task 128 on those later-updated records 110 may cause inconsistencies in the state of the data stored by the records 110.

In one example, a database task 128 may be generated to delete or modify a plurality of records 110 in the non-relational database 108 at 2 PM on July 1^{st}. The plurality of records 110 that are subject to the database task may be stored in the main dataset 111 (e.g., Record A), the derived dataset 113a (e.g., Record B), and the derived dataset 113b (e.g., Record C). A data service 106 may update Record B stored in the derived dataset 113a at 3 PM on July 1^{st}. After 2 PM on July 1^{st}, the task manager 126 may use the database snapshot 120a to identify the records 110 (including Record A, Record B, and Record C). The update to the record at 3 PM by the data service 106 may cause Record B to not be applicable to the database task 128. However, according to the techniques discussed herein, the change applier 122 is configured to determine not to apply the change or deletion to Record B. If Record A and Record C have not been updated after the time instance associated with the database task 128, the task manager 126 is configured to apply the updates to Record A and Record C. Then, the task manager 126 is configured to re-execute the database task 128 using the database snapshot 120b. If Record B is on the update log 134, the change applier 122 is configured to determine whether there has been an update to Record B since the re-executed database task 128. If no, the change applier 122 is configured to apply the change or deletion to Record B. In this manner, records 110 may be updated in the non-relational database 108 in a consistent manner.

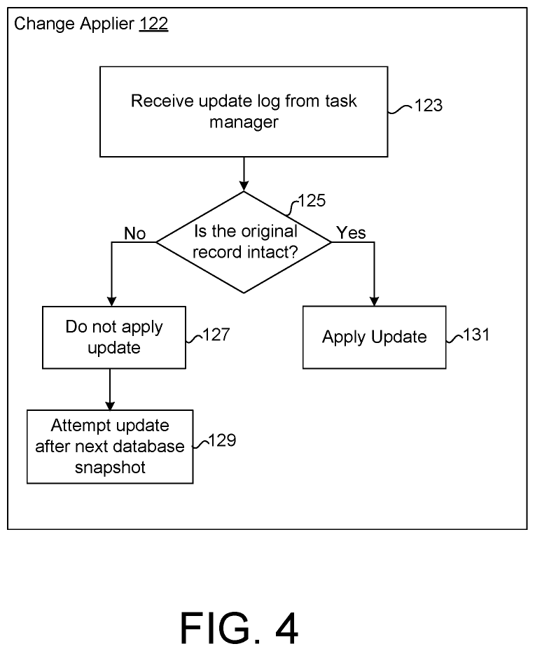

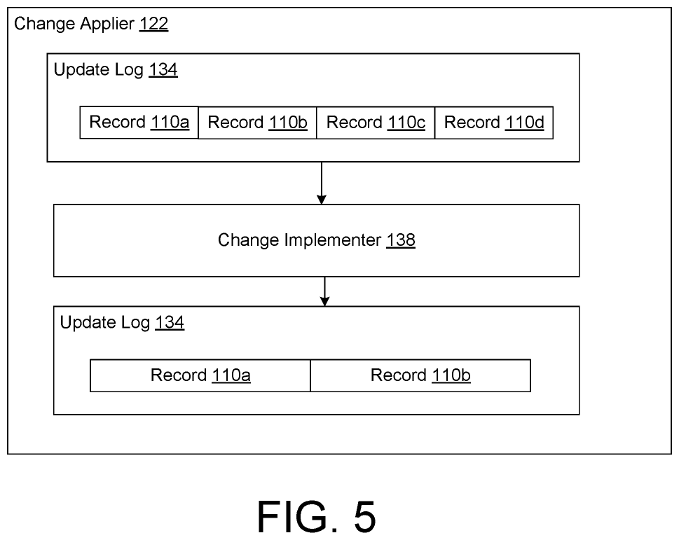

Referring to FIG. 4, in operation 123, the change applier 122 may receive an update log 134 from the task manager 126. The update log 134 may have been generated in response to a database task 128 executed on the database snapshot 120a. As shown in FIG. 5, the update log 134 may identify a plurality of records including record 110a, record 110b, record 110c, and record 110d. For each record 110 identified in the update log 134, in operation 125, the change applier 122 may determine whether the original record is intact (e.g., whether the record has been modified). Although the following description is explained with reference to record 110a, the change applier 122 may execute the same operations with respect to record 110b, record 110c, and record 110d. Also, in FIG. 5, the change applier 122 has determined to implement the changes to record 110c and record 110b but defer the changes to record 110a and record 110b until a subsequent database snapshot 120 is available.

The change applier 122 may determine whether record 110a has been updated in the non-relational database 108 after a time instance associated with the database task 128 (e.g., determining whether the original record is intact). In some examples, the time instance relates to the timestamp associated with the record 110a in the database snapshot 120a. In response to the record 110a not being determined as updated after the time instance associated with the database task 128, in operation 131, the change applier 122 may apply the change or deletion of the record 110a in the non-relational database 108. For example, the change applier 122 may include a change implementer 138 configured to implement the change or deletion of the record 110a in the non-relational database 108. In response to the record 110a being determined as updated after the time instance associated with the database task 128, in operation 127, the change applier 122 may not apply the change or deletion of the record 110a in the non-relational database 108. In operation 129, the change applier 122 may attempt to update after the next database snapshot is available.

In some examples, the change applier 122 may compare timestamps to determine whether the record 110a stored in the non-relational database 108 has been updated after a time instance associated with the database task 128. For example, a first timestamp of the record 110a may be obtained from the non-relational database 108. The first timestamp may provide the time in which the record 110a was last updated in the non-relational database 108. A second timestamp may be associated with the database task 128. In some examples, the second timestamp may provide the time in which the record 110a was captured in the database snapshot 120a. In some examples, the second timestamp is the time which the database task 128 was initiated. The change applier 122 may compare the first timestamp with the second timestamp, and if the time indicated by the first timestamp is after the time indicated by the second timestamp, the change applier 122 may not apply the change or deletion of the record 110a in the non-relational database 108. The change applier 122 may compare the first timestamp with the second timestamp, and if the time indicated by the first timestamp is before the time indicated by the second timestamp, the change applier 122 may apply the change or deletion of the record 110a in the non-relational database 108.

In some examples, instead of using timestamps, the change applier 122 may compare the contents of the record 110a from the update log 134 (e.g., the database snapshot 120a) with the contents of the record 110a in the non-relational database 108. If they are the same, the change applier 122 may apply the change or deletion of the record 110a in the non-relational database 108. If they are different, the change applier 122 may not apply the change or deletion of the record 110a in the non-relational database 108. In some examples, the change applier 122 may use compare-and-swap (CAS) operations to compare the contents.

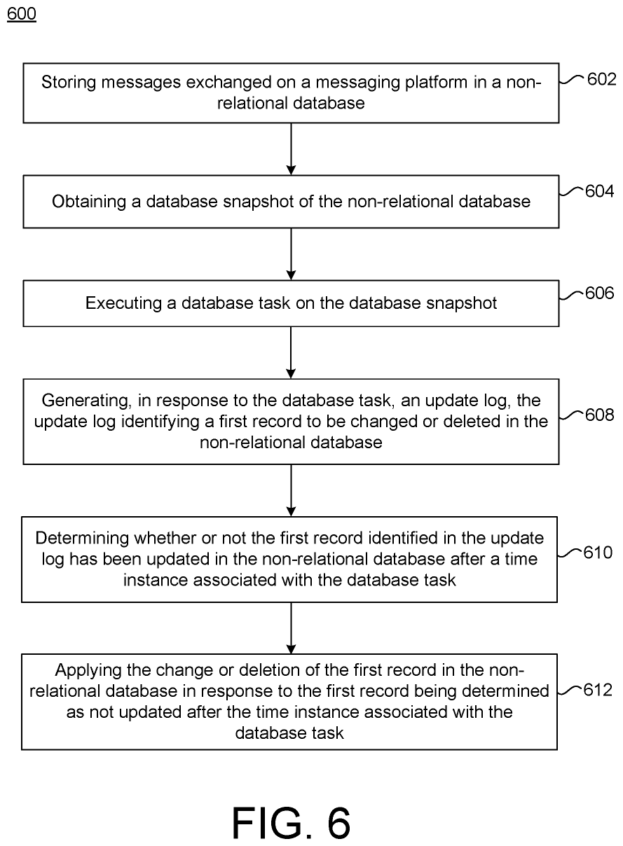

FIG. 6 illustrates a flowchart 600 depicting example operations of updating recordings in a non-relational database according to an aspect. The flowchart 600 is explained with respect to the system 100 of FIGS. 1 through 5. Although the flowchart 6 of FIG. 6 illustrates the operations in sequential order, it will be appreciated that this is merely an example, and that additional or alternative operations may be included. Further, operations of FIG. 6 and related operations may be executed in a different order than that shown, or in a parallel or overlapping fashion.

Operation 602 storing messages 112 exchanged on a messaging platform 104 in a non-relational database 108. Operation 604 includes obtaining a database snapshot 120 of the non-relational database 108. Operation 606 includes executing a database task 128 on the database snapshot 120. Operation 608 includes generating, in response to the database task 128, an update log 134, the update log 134 identifying a first record to be changed or deleted in the non-relational database 108. Operation 610 includes determining whether or not the first record identified in the update log 134 has been updated in the non-relational database 108 after a time instance associated with the database task 128. Operation 612 includes applying the change or deletion to the first record in the non-relational database 108 in response to the first record being determined as not updated after the time instance associated with the database task 128. In some examples, the operations include not applying the change or deletion of the first record in the non-relational database 108 in response to the first record being determined as updated after the time instance associated with the database task 128.

Although the disclosed concepts include those defined in the attached claims, it should be understood that the concepts can also be defined in accordance with the following examples:

Example 1. A method comprising: storing messages exchanged on a messaging platform in a non-relational database; obtaining a database snapshot of the non-relational database; executing a database task on the database snapshot; generating, in response to the database task, an update log, the update log identifying a first record to be changed or deleted in the non-relational database; determining whether or not the first record identified in the update log has been updated in the non-relational database after a time instance associated with the database task; and applying the change or deletion of the first record in the non-relational database in response to the first record being determined as not updated after the time instance associated with the database task.

Example 2. The method of Example 1, further comprising: not applying the change or deletion of the first record in the non-relational database in response to the first record being determined as updated after the time instance associated with the database task.

Example 3. The method of Example 1 or 2, the method comprising: comparing a first timestamp associated with the first record in the non-relational database and a second timestamp associated with the first record in the database snapshot.

Example 4. The method of any of Examples 1 through 3, wherein the change or deletion of the first record in the non-relational database is applied in response to a time of the first timestamp being before a time of the second timestamp.

Example 5. The method of any of Examples 1 through 4, further comprising: comparing a content of the first record in the database snapshot with a content of the first record in the non-relational database.

Example 6. The method of any of Examples 1 through 5, wherein the change or deletion of the first record in the non-relational database is applied in response to the content of the first record in the non-relational database being determined as the same as the content of the first record in the database snapshot.

Example 7. The method of any of Examples 1 through 6, further comprising: obtaining a sequence of database snapshots over time, the sequence of database snapshots including a first database snapshot obtained during a first period of time, and a second database snapshot obtained during a second period of time.

Example 8. The method of any of Examples 1 through 7, wherein the database snapshot is a first database snapshot, the method further comprising: obtaining a second database snapshot of the non-relational database, the second database snapshot being obtained after the first database snapshot.

Example 9. The method of any of Examples 1 through 8, further comprising: re-generating, in response to a subsequent database task, the update log, the re-generated update log identifying the first record.

Example 10. The method of any of Examples 1 through 9, further comprising: determining whether or not the first record identified in the re-generated update log has been updated in the non-relational database after a time instance associated with the subsequent database task.

Example 11. The method of any of Examples 1 through 10, further comprising: applying the change or deletion of the first record in the non-relational database in response to the first record being determined as not changed after the time instance associated with the subsequent database task.

Example 12. The method of any of Examples 1 through 11, further comprising: storing the database snapshot in an offline storage system, the offline storage system being separate from the non-relational database.

Example 13. The method of any of Examples 1 through 12, wherein the database task is a deletion event configured to delete records in the non-relational database associated with a plurality of user accounts of the messaging platform.

Example 14. The method of any of Examples 1 through 13, wherein the first record includes a message exchanged on the messaging platform from a user account of the plurality of user accounts.

Example 15. The method of any of Examples 1 through 14, wherein the message has a message identifier.

Example 16. The method of any of Examples 1 through 15, wherein the database task is configured to cause deletion of any records associated with the message identifier from the non-relational database.

Example 17. A non-transitory computer-readable storage medium comprising instructions stored thereon that, when executed by at least one processor, are configured to cause a computing system to perform the method of any of Examples 1 through 16.

Example 18. An apparatus comprising means for performing the method of any of Examples 1 through 16.

Example 19. An apparatus comprising: at least one processor; and at least one memory including computer program code; the at least one memory and the computer program code configured to, with the at least one processor, cause the apparatus at least to perform the method of any of Examples 1 through 16.

Example 20. A messaging system comprising: a non-relational database configured to store messages exchanged on a messaging platform in a non-relational database; a database manager configured to obtain, over time, a sequence of database snapshots of the non-relational database, the sequence of database snapshots including a first database snapshot; a task manager configured to execute a database task on the first database snapshot to generate an update log, the update log identifying a plurality of records to be changed or deleted in the non-relational database; and a change applier configured to determine, for each of the plurality of records identified in the update log, whether or not a record has been updated in the non-relational database after a time instance associated with the database task, the change applier configured to apply the change or deletion of the record in the non-relational database in response to the record being determined as not updated after the time instance associated with the database task.

Example 21. The messaging system of Example 20, wherein the non-relational database is an unstructured database, the unstructured database not including an index.

Example 22. The messaging system of Example 20 or 21, wherein the change applier is configured to not apply the change or deletion of the record in the non-relational database in response to the record being determined as updated after the time instance associated with the database task.

Example 23. The messaging system of any of Examples 20 through 22, wherein the change applier is configured to compare a first timestamp associated with the record in the first database snapshot with a second timestamp associated with the record stored in the non-relational database.

Example 24. The messaging system of any of Examples 20 through 23, wherein the change applier is configured to not change or delete the record in the non-relational database in response to a time of the second timestamp being after a time of the first timestamp.

Example 25. The messaging system of any of Examples 20 through 24, wherein the change applier is configured to compare a content of the first record in the first database snapshot with a content of the first record in the non-relational database.

Example 26. The messaging system of any of Examples 20 through 25, wherein the change applier is configured to not change or delete the record in the non-relational database in response to the content of the first record in the non-relational database being different from the content of the first record in the first database snapshot.

Example 27. The messaging system of any of Examples 20 through 26, wherein the sequence of database snapshots includes a second database snapshot.

Example 28. The messaging system of any of Examples 20 through 27, wherein the task manager is configured to re-generate, in response to a subsequent database task, the update log using the second database snapshot.

Example 29. A method having steps according to any of Examples 20 through 28.

Example 30. A non-transitory computer-readable storage medium comprising instructions stored thereon that, when executed by at least one processor, are configured to cause a computing system to perform the operations of any of Examples 20 through 28.

Example 31. An apparatus comprising means for performing the operations of any of Examples 20 through 28.

Example 32. A non-transitory computer-readable medium storing executable instructions that when executed by at least one processor cause the at least one processor to: store messages exchanged on a messaging platform in a non-relational database; obtain, over time, a sequence of database snapshots of the non-relational database, the sequence of database snapshots including a first database snapshot and a second database snapshot; execute a database task on the first database snapshot to generate an update log, the update log identifying a plurality of records to be changed or deleted in the non-relational database; and determine, for each of the plurality of records identified in the update log, whether or not a record has been updated in the non-relational database after a time instance associated with the database task; not apply the change or deletion of the record in the non-relational database in response to the record being determined as updated after the time instance associated with the database task; and attempt to apply the change or deletion of the record in the non-relational database using the second database snapshot.

Example 33. The non-transitory computer-readable medium of Example 32, wherein the executable instructions include instructions that when executed by the at least one processor cause the at least one processor to: compare a first timestamp associated with the record in the first database snapshot with a second timestamp associated with the record stored in the non-relational database.

Example 34. The non-transitory computer-readable medium of Example 32 or 33, wherein the executable instructions include instructions that when executed by the at least one processor cause the at least one processor to not change or delete the record in the non-relational database in response to a time of the second timestamp being after a time of the first timestamp.

Example 35. The non-transitory computer-readable medium of any of Examples 32 through 34, wherein the executable instructions include instructions that when executed by the at least one processor cause the at least one processor to compare a content of the first record in the first database snapshot with a content of the first record in the non-relational database using one or more compare-and-swap (CAS) operations.

Example 36. The non-transitory computer-readable medium of any of Examples 32 through 35, wherein the executable instructions include instructions that when executed by the at least one processor cause the at least one processor to not change or delete the record in the non-relational database in response to the content of the first record in the non-relational database being different from the content of the first record in the first database snapshot.

Example 37. The non-transitory computer-readable medium of any of Examples 32 through 36, wherein the database task is a deletion event configured to delete records in the non-relational database associated with a plurality of user accounts that are unsubscribed from the messaging platform.

Example 38. The non-transitory computer-readable medium of any of Examples 32 through 37, wherein the non-relational database includes a main dataset and at least one derived dataset.

Example 39. The non-transitory computer-readable medium of any of Examples 32 through 38, wherein the plurality of records include messages exchanged on the messaging platform from the plurality of user accounts.

Example 40. The non-transitory computer-readable medium of any of Examples 32 through 39, wherein the database task is configured to cause deletion of any records associated with the plurality of user accounts from the main dataset and the at least one derived dataset.

Example 41. A method having steps according to any of Examples 32 through 40.

Example 42. An apparatus comprising: at least one processor; and at least one memory including computer program code; the at least one memory and the computer program code configured to, with the at least one processor, cause the apparatus at least to perform the operations of any of Examples 32 through 40.

Example 43. An apparatus comprising means for performing the operations of any of Examples 32 through 40.

In the above description, numerous details are set forth. It will be apparent, however, to one of ordinary skill in the art having the benefit of this disclosure, that implementations of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “storing,” “obtaining,” “executing,” “generating,” “transmitting,” “receiving,” “generating,” “comparing,” “applying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Implementations of the disclosure also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several implementations of the present disclosure. It will be apparent to one skilled in the art, however, that at least some implementations of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

What is claimed is:

1. A method comprising:
storing messages exchanged on a messaging platform in a non-relational database;
obtaining a database snapshot of the non-relational database;
executing a database task on the database snapshot;
generating, in response to the database task, an update log, the update log identifying a first record to be changed or deleted in the non-relational database;
determining whether or not the first record identified in the update log has been updated in the non-relational database after a time instance associated with the database task; and
applying the change or deletion of the first record in the non-relational database in response to the first record being determined as not updated after the time instance associated with the database task.

2. The method of claim 1, further comprising:
not applying the change or deletion of the first record in the non-relational database in response to the first record being determined as updated after the time instance associated with the database task.

3. The method of claim 1, the method comprising:
comparing a first timestamp associated with the first record in the non-relational database and a second timestamp associated with the first record in the database snapshot,
wherein the change or deletion of the first record in the non-relational database is applied in response to a time of the first timestamp being before a time of the second timestamp.

4. The method of claim 1, further comprising:
comparing a content of the first record in the database snapshot with a content of the first record in the non-relational database,
wherein the change or deletion of the first record in the non-relational database is applied in response to the content of the first record in the non-relational database being determined as the same as the content of the first record in the database snapshot.

5. The method of claim 1, further comprising:
obtaining a sequence of database snapshots over time, the sequence of database snapshots including a first database snapshot obtained during a first period of time, and a second database snapshot obtained during a second period of time.

6. The method of claim 1, wherein the database snapshot is a first database snapshot, the method further comprising:
obtaining a second database snapshot of the non-relational database, the second database snapshot being obtained after the first database snapshot;
re-generating, in response to a subsequent database task, the update log, the re-generated update log identifying the first record;
determining whether or not the first record identified in the re-generated update log has been updated in the non-relational database after a time instance associated with the subsequent database task; and
applying the change or deletion of the first record in the non-relational database in response to the first record being determined as not changed after the time instance associated with the subsequent database task.

7. The method of claim 1, further comprising:
storing the database snapshot in an offline storage system, the offline storage system being separate from the non-relational database.

8. The method of claim 1, wherein the database task is a deletion event configured to delete records in the non-relational database associated with a plurality of user accounts of the messaging platform.

9. The method of claim 8, wherein the first record includes a message exchanged on the messaging platform from a user account of the plurality of user accounts, the message having a message identifier, the database task configured to cause deletion of any records associated with the message identifier from the non-relational database.

10. A messaging system comprising:
a non-relational database configured to store messages exchanged on a messaging platform in a non-relational database;
a database manager configured to obtain, over time, a sequence of database snapshots of the non-relational database, the sequence of database snapshots including a first database snapshot;
a task manager configured to execute a database task on the first database snapshot to generate an update log, the update log identifying a plurality of records to be changed or deleted in the non-relational database; and
a change applier configured to determine, for each of the plurality of records identified in the update log, whether or not a record has been updated in the non-relational database after a time instance associated with the database task,
the change applier configured to apply the change or deletion of the record in the non-relational database in response to the record being determined as not updated after the time instance associated with the database task.

11. The messaging system of claim 10, wherein the non-relational database is an unstructured database, the unstructured database not including an index.

12. The messaging system of claim 10, wherein the change applier is configured to not apply the change or deletion of the record in the non-relational database in response to the record being determined as updated after the time instance associated with the database task.

13. The messaging system of claim 10, wherein the change applier is configured to compare a first timestamp associated with the record in the first database snapshot with a second timestamp associated with the record stored in the non-relational database, the change applier configured to not change or delete the record in the non-relational database in response to a time of the second timestamp being after a time of the first timestamp.

14. The messaging system of claim 10, wherein the change applier is configured to compare a content of the first record in the first database snapshot with a content of the first record in the non-relational database, the change applier configured to not change or delete the record in the non-relational database in response to the content of the first record in the non-relational database being different from the content of the first record in the first database snapshot.

15. The messaging system of claim 10, wherein the sequence of database snapshots includes a second database snapshot, the task manager configured to re-generate, in response to a subsequent database task, the update log using the second database snapshot.

16. A non-transitory computer-readable medium storing executable instructions that when executed by at least one processor cause the at least one processor to:
store messages exchanged on a messaging platform in a non-relational database;
obtain, over time, a sequence of database snapshots of the non-relational database, the sequence of database snapshots including a first database snapshot and a second database snapshot;
execute a database task on the first database snapshot to generate an update log, the update log identifying a plurality of records to be changed or deleted in the non-relational database;
determine, for each of the plurality of records identified in the update log, whether or not a record has been updated in the non-relational database after a time instance associated with the database task;
not apply the change or deletion of the record in the non-relational database in response to the record being determined as updated after the time instance associated with the database task; and
attempt to apply the change or deletion of the record in the non-relational database using the second database snapshot.

17. The non-transitory computer-readable medium of claim 16, wherein the executable instructions include instructions that when executed by the at least one processor cause the at least one processor to:
compare a first timestamp associated with the record in the first database snapshot with a second timestamp associated with the record stored in the non-relational database; and
not change or delete the record in the non-relational database in response to a time of the second timestamp being after a time of the first timestamp.

18. The non-transitory computer-readable medium of claim 16, wherein the executable instructions include instructions that when executed by the at least one processor cause the at least one processor to:
compare a content of the first record in the first database snapshot with a content of the first record in the non-relational database using one or more compare-and-swap (CAS) operations; and
not change or delete the record in the non-relational database in response to the content of the first record in the non-relational database being different from the content of the first record in the first database snapshot.

19. The non-transitory computer-readable medium of claim 16, wherein the database task is a deletion event configured to delete records in the non-relational database associated with a plurality of user accounts that are unsubscribed from the messaging platform.

20. The non-transitory computer-readable medium of claim 19, wherein the non-relational database includes a main dataset and at least one derived dataset, wherein the plurality of records include messages exchanged on the messaging platform from the plurality of user accounts, the database task configured to cause deletion of any records associated with the plurality of user accounts from the main dataset and the at least one derived dataset.
